(19) United States
(12) Patent Application Publication
(10) Pub. No.: US 2003/0030583 A1
(43) Pub. Date: Feb. 13, 2003

(54) System and method of emergency apparatus pre-deployment using impulse radio radar

(76) Inventor: James S. Finn, Huntsville, AL (US)

Correspondence Address: James S. Finn, 7057 Old Madison Pike, Huntsville, AL, 35801, US

(21) Appl. No.: 09/922,213

(22) Filed: Aug. 6, 2001

(51) Int. Cl. G01S 13/93

(52) U.S. Cl. 342/70; 342/71; 342/72; 342/106; 342/114

(57) ABSTRACT

The present invention is an emergency apparatus deployment system and method. The emergency apparatus, such as an airbag, is pre-deployed or, in the case of a braking system, simply activated based on information determined by impulse radio radar means relating to the distance and closure between two objects, such as between an automobile and a tree or between two automobiles. Upon information that a collision between two objects is imminent, the emergency apparatus, for example, an airbag, is deployed immediately prior to the collision.

### BACKGROUND OF THE INVENTION

### FIELD OF THE INVENTION

The invention relates generally to emergency apparatus (such as automobile airbags) deployment systems and methods. More particularly this invention relates to pre-deploying emergency apparatus such as airbags prior to a crash. Still more particularly this invention relates to using impulse radio radar techniques to predict the imminence of a crash, thereby allowing pre-deployment of airbags or other safety measures.

### BACKGROUND OF THE INVENTION AND RELATED ART

Present day automobile airbag safety systems rely on sensors to provide indication during a crash that the crash is of sufficient severity to warrant the deployment of an airbag. These sensors are reactive in the sense that they can only measure the response of the car during the actual physical crash. The sensor system however, must provide adequate warning to permit airbag deployment. A general rule of performance is the “5 inch—30 millisecond” rule: as a general norm, an airbag must be fully deployed after a travel of 5 inches in the front seat of the passenger compartment, where the travel is defined as the integration of the velocity change during the accident at the location of the passenger compartment. Since it takes approximately 30 milliseconds to deploy a passenger side airbag fully, the sensor system must provide an indication 30 milliseconds before the front seat has traveled 5 inches during the crash. In assessing this requirement it is helpful to recall that a vehicle traveling at 60 miles per hour is traveling at 88 feet per second or 0.88 feet per 10 milliseconds.

In addition to providing this advance indication, the sensor system must be capable of separating “must-fire” crashes from “no-fire” crashes, since not all crashes are severe enough to warrant the deployment of an airbag. Typically for a frontal crash, a velocity of 14 mph separates crashes requiring an airbag from those that do not require an airbag.

Sensors that are employed include mechanical, electromechanical and electronic devices. A mechanical sensor might involve the movement of a mass against a restraint arm. If the movement is sufficient, a spring loaded firing pin is released, puncturing a primer that initiates the airbag firing. In an electromechanical sensor, such as the ball-in-tube sensor, an electrical contact is closed if a magnetically restrained ball breaks free and closes the contacts of an external circuit. Both mechanical and electromechanical sensors are located near the point of initial contact, i.e. the front of the vehicle for frontal crashes. More than one sensor is usually required. In the mechanical and electromechanical sensor systems, the separation of “must-fire” crashes from “no-fire” crashes is accomplished with bias and damping parameters built into the sensor design, since these sensors are basically switches.

Electronic sensors rely on micromachined silicon capacitive or piezoresistive accelerometers. These sensors are typically located on a structural component close to the front of the passenger compartment, and measure the acceleration along the longitudinal axis of the car. The output of the electronic sensor is a voltage proportional to the acceleration along the axis of the vehicle. A microcontroller continually monitors the electronic sensor output and by means of a suitable algorithm determines if a crash is occurring and if it is severe enough to warrant airbag deployment.

Whereas mechanical and electromechanical systems typically require several sensors, some of which are located close to the front of the vehicle, and a system diagnostic unit, the electronic sensor can be configured as a single unit. Because of the advantages of this arrangement, the present industry trend is towards a single electronic sensor located on a structural component near the front of the passenger compartment.

The response of any sensing system is both vehicle specific and crash specific. While some vehicles and some crashes are relatively easy for the sensing system to diagnose, others are not. Two types of condition present particular difficulty: pole crashes and rough road conditions. In the case of pole crashes, it has been found that a pole can effectively slice through the front of the vehicle a considerable distance, using up valuable time, until the signature of a severe crash is recognized. In the latter case, rough roads can provide false indications of a crash.

For side impact crashes, the situation is more severe since the extent of the vehicle between the impacting object and the vehicle interior is much less than frontal crashes, providing less time for interpretation of data and for an airbag deployment decision.

In addition to these considerations, potentially adverse consequences of full airbag deployment when passengers are out of position, are leading to the development of “smart” airbag systems that deploy on the basis of occupant size and position. Pretensioning of seat belt restraints and integration of seat belt systems with “smart” airbag systems is also under development.

Further, predetermination of imminent collisions have been developed using infra red techniques. For example, U.S. Pat. No. 6,012,008 entitled, “Method and apparatus for predicting a crash and reacting thereto”, invented by Robert L. Scully and issued Jan. 4, 2000, describes a method of predicting a crash using infra red to predict an imminent collision. However, since the method of determining imminent collision uses infra red it is plagued by the drawbacks inherent with the technology. First, since it is an optical solution it is inherently line of sight and can be unreliable. For example, it cannot determine the size of the object with which you are going to collide. Thus, an empty box that has blown onto the road could set off the airbag but would not justify deployment of the airbag. Also, weather concerns may be an issue as a severe thunderstorm may interfere with the inherently optical solution. Lastly, very problematic would be if the lens were inadvertently covered with, for example, mud. This would inhibit and actually may cause the failure of an optical system.

Hence, there is a need in the art to provide a system and method of predicting crashes and thereby enabling the pre-deployment of a safety system such as an airbag. Further, said system and method should predict the imminence of a crash using a technique other than infrared, with its concomitant limitations.

### SUMMARY OF THE INVENTION

With these considerations in mind, an advance warning of a crash would be of value in preparing vehicle safety systems for an impact. Knowledge of where the contact will occur and the potential severity based on relative velocity would permit algorithms monitoring accelerometer based sensors to come to a decision at an earlier time during the actual crash. A predictive collision sensing system would provide this additional warning.

Further, a predictive collision sensing system could provide advance warning of a high velocity impact in a limited area, which is characteristic of a pole crash, as well as an all clear signal across the front of a vehicle supporting a rough road determination by the safety system diagnostic unit. A predictive collision sensing system could also provide significant value for a vehicle side impact system, where response time requirements for reactive sensors are severe. A predictive collision sensing system could provide an early alert to safety restraint and “smart” airbag systems currently under development.

The method and apparatus of the present invention projects an impulse radio radar envelope outwards from the surface of the vehicle and detects objects, either stationary or mobile, that intrude into this volume. This envelope is kept as close to the surface of the vehicle as is possible, e.g. on the order of two to six feet and preferably about four feet, to eliminate the requirements of processing extraneous signals and to eliminate the generation of false indications. Nevertheless, the system of the present invention is capable of providing a warning approximately 10 to 40 milliseconds before collision occurs.

In a distinct embodiment, longer distances can be utilized by simply modify the impulse radio range gate. This may be beneficial in for example, a cruise control deactivation and concomitant braking system. The distance between two vehicles can be determined by impulse radio radar means, and subsequent actions can be taken. For example, while a car is in cruise control mode, if the distance between and closure of two vehicles is such that the cruise control should be deactivated and brakes applied, this information can be provided by the impulse radio radar and interfaced with a controller and the cruise control will be automatically deactivated and, if warranted, brakes applied. It is important to note that this system is not advantageously incorporated into the airbag system, as deployment of the airbag is a last resort and an emergency procedure only to be taken in the event of an imminent crash.

In the below described preferred embodiment, the invention is implemented in a system comprising a control unit and one or multiple impulse radio radar units that working together locate approaching obstacles, by time-of-flight analysis calculate the time-to-impact, and provide indication of an imminent collision. This indication can then, for example, be used to actuate the airbags in a conventional airbag system.

Advantageously, the system is implemented using impulse radio radars with range gating unique to impulse radio radars and thereby can detect the imminence of a collision and the time until the collision by integrating a digital clock for elapsed time measurement; and one or more digital signal processors or microprocessors for system control and algorithm realization.

In this embodiment (as opposed to the cruise control embodiment above) limiting the sensing distance to close distances, e.g. four feet, removes the necessity for target tracking that is a characteristic of present collision avoidance systems. The technique and system described herein recognizes that the closer the decision is made to the surface of the vehicle, the more reliable the indication. With a decision being made at a distance of approximately two feet, the probability of a contact not occurring for velocities that would require an airbag is virtually zero, since the deceleration necessary to prevent a collision is beyond the capabilities of the vehicle operator. For example, at a distance of 2 feet from an obstacle and with a vehicle moving at 14 miles per hour, the lowest velocity of impact requiring a frontal airbag, the braking required to prevent collision is larger than 3 g's. Even though a decision is not made until this close approach has been realized, the warning of 10 to 40 milliseconds that is provided by the system of the present invention is still of value to occupant safety systems.

The limitation of radar ranging distances in the preferred embodiment to approximately four feet has additional advantages that include increased probability of receiving reflected signals, even under adverse weather conditions.

Regarding placement of the radar, unlike optical solutions, subtler placement is possible. The units can be placed, for example, behind a plastic bumper and out of view or on the side under molding. Also, debris and other matter on the surface will not inhibit the functioning of the system.

It is to be understood that both the foregoing general description and the following detailed description are exemplary and explanatory and are intended to provide further explanation of the invention as claimed.

Other objects and advantages will become apparent during the following description of the presently preferred embodiment of the invention taken in conjunction with the drawings.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates a representative Gaussian Monocycle waveform in the time domain;

FIG. 1B illustrates the frequency domain amplitude of the Gaussian Monocycle of FIG. 1A;

FIG. 1C represents the second derivative of the Gaussian Monocycle of FIG. 1A;

FIG. 1D represents the third derivative of the Gaussian Monocycle of FIG. 1A;

FIG. 1E represents the Correlator Output vs. the Relative Delay in a real data pulse;

FIG. 1F graphically depicts the frequency plot of the Gaussian family of the Gaussian Pulse and the first, second, and third derivative.

FIG. 2A illustrates a pulse train comprising pulses as in FIG. 1A;

FIG. 2B illustrates the frequency domain amplitude of the waveform of FIG. 2A;

FIG. 2C illustrates the pulse train spectrum;

FIG. 2D is a plot of the Frequency vs. Energy Plot and points out the coded signal energy spikes;

FIG. 3 illustrates the cross-correlation of two codes graphically as Coincidences vs. Time Offset;

FIGS. 4A-4E graphically illustrate five modulation techniques to include: Early-Late Modulcation; One of Many Modulation; Flip Modulation; Quad Flip Modulation; and Vector Modulation;

FIG. 5A illustrates representative signals of an interfering signal, a coded received pulse train and a coded reference pulse train;

FIG. 5B depicts a typical geometrical configuration giving rise to multipath received signals;

FIG. 5C illustrates exemplary multipath signals in the time domain;

FIGS. 5D-5F illustrate a signal plot of various multipath environments.

FIGS. 5G illustrates the Rayleigh fading curve associated with non-impulse radio transmissions in a multipath environment.

FIG. 5H illustrates a plurality of multipaths with a plurality of reflectors from a transmitter to a receiver.

FIG. 5I graphically represents signal strength as volts vs. time in a direct path and multipath environment.

FIG. 6 illustrates a representative impulse radio transmitter functional diagram;

FIG. 7 illustrates a representative impulse radio receiver functional diagram;

FIG. 8A illustrates a representative received pulse signal at the input to the correlator;

FIG. 8B illustrates a sequence of representative impulse signals in the correlation process;

FIG. 8C illustrates the output of the correlator for each of the time offsets of FIG. 8B.

FIG. 9 is a block diagram illustrating a preferred embodiment of the invention;

FIG. 10 is a flowchart depicting the processing of information within the system;

FIG. 11 is a plot depicting time-to-impact as a function of closing velocity with isochrones for specific times-to-impact;

FIG. 12 is a plot depicting time-to-impact vs. distance for given closing velocities;

FIG. 13 is a schematic depicting the invention mounted on the front of a vehicle using multiple radars (although it is understood that a single radar is possible); and

FIG. 14 is a schematic depicting the invention mounted on the side of the vehicle using a single impulse radio radars.

### DETAILED DESCRIPTION OF THE EMBODIMENTS

Overview of the Invention

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art. Like numbers refer to like elements throughout.

Impulse Radio Technology Overview

Recent advances in communications technology have enabled ultra wideband technology (UWB) or impulse radio communications systems “impulse radio”. To better understand the benefits of impulse radio to the present invention, the following review of impulse radio follows. Impulse radio has been described in a series of patents, including U.S. Pat. Nos. 4,641,317 (issued Feb. 3, 1987), 4,813,057 (issued Mar. 14, 1989), 4,979,186 (issued Dec. 18, 1990) and 5,363,108 (issued Nov. 8, 1994) to Larry W. Fullerton. A second generation of impulse radio patents includes U.S. Pat. Nos. 5,677,927 (issued Oct. 14, 1997), 5,687,169 (issued Nov. 11, 1997), 5,764,696 (issued Jun. 9, 1998), and 5,832,035 (issued Nov. 3, 1998) to Fullerton et al.

Uses of impulse radio systems are described in U.S. patent application Ser. No. 09/332,502, titled, “System and Method for Intrusion Detection using a Time Domain Radar Array” and U.S. patent application Ser. No. 09/332,503, titled, “Wide Area Time Domain Radar Array” both filed on Jun. 14, 1999 both of which are assigned to the assignee of the present invention. The above patent documents are incorporated herein by reference.

This section provides an overview of impulse radio technology and relevant aspects of communications theory. It is provided to assist the reader with understanding the present invention and should not be used to limit the scope of the present invention. It should be understood that the terminology ‘impulse radio’ is used primarily for historical convenience and that the terminology can be generally interchanged with the terminology ‘impulse communications system, ultra-wideband system, or ultra-wideband communication systems’. Furthermore, it should be understood that the described impulse radio technology is generally applicable to various other impulse system applications including but not limited to impulse radar systems and impulse positioning systems. Accordingly, the terminology ‘impulse radio’ can be generally interchanged with the terminology ‘impulse transmission system and impulse reception system.’

Impulse radio refers to a radio system based on short, low duty-cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Many waveforms having very broad, or wide, spectral bandwidth approximate a Gaussian shape to a useful degree.

Impulse radio can use many types of modulation, including amplitude modulation, phase modulation, frequency modulation, time-shift modulation (also referred to as pulse-position modulation or pulse-interval modulation) and M-ary versions of these. In this document, the time-shift modulation method is often used as an illustrative example. However, someone skilled in the art will recognize that alternative modulation approaches may, in some instances, be used instead of or in combination with the time-shift modulation approach.

In impulse radio communications, inter-pulse spacing may be held constant or may be varied on a pulse-by-pulse basis by information, a code, or both. Generally, conventional spread spectrum systems employ codes to spread the normally narrow band information signal over a relatively wide band of frequencies. A conventional spread spectrum receiver correlates these signals to retrieve the original information signal. In impulse radio communications, codes are not typically used for energy spreading because the monocycle pulses themselves have an inherently wide bandwidth. Codes are more commonly used for channelization, energy smoothing in the frequency domain, resistance to interference, and reducing the interference potential to nearby receivers. Such codes are commonly referred to as time-hopping codes or pseudo-noise (PN) codes since their use typically causes inter-pulse spacing to have a seemingly random nature. PN codes may be generated by techniques other than pseudorandom code generation. Additionally, pulse trains having constant, or uniform, pulse spacing are commonly referred to as uncoded pulse trains. A pulse train with uniform pulse spacing, however, may be described by a code that specifies non-temporal, i.e., non-time related, pulse characteristics.

In impulse radio communications utilizing time-shift modulation, information comprising one or more bits of data typically time-position modulates a sequence of pulses. This yields a modulated, coded timing signal that comprises a train of pulses from which a typical impulse radio receiver employing the same code may demodulate and, if necessary, coherently integrate pulses to recover the transmitted information.

The impulse radio receiver is typically a direct conversion receiver with a cross correlator front-end that coherently converts an electromagnetic pulse train of monocycle pulses to a baseband signal in a single stage. The baseband signal is the basic information signal for the impulse radio communications system. A subcarrier may also be included with the baseband signal to reduce the effects of amplifier drift and low frequency noise. Typically, the subcarrier alternately reverses modulation according to a known pattern at a rate faster than the data rate. This same pattern is used to reverse the process and restore the original data pattern just before detection. This method permits alternating current (AC) coupling of stages, or equivalent signal processing, to eliminate direct current (DC) drift and errors from the detection process. This method is described in more detail in U.S. Pat. No. 5,677,927 to Fullerton et al.

Waveforms

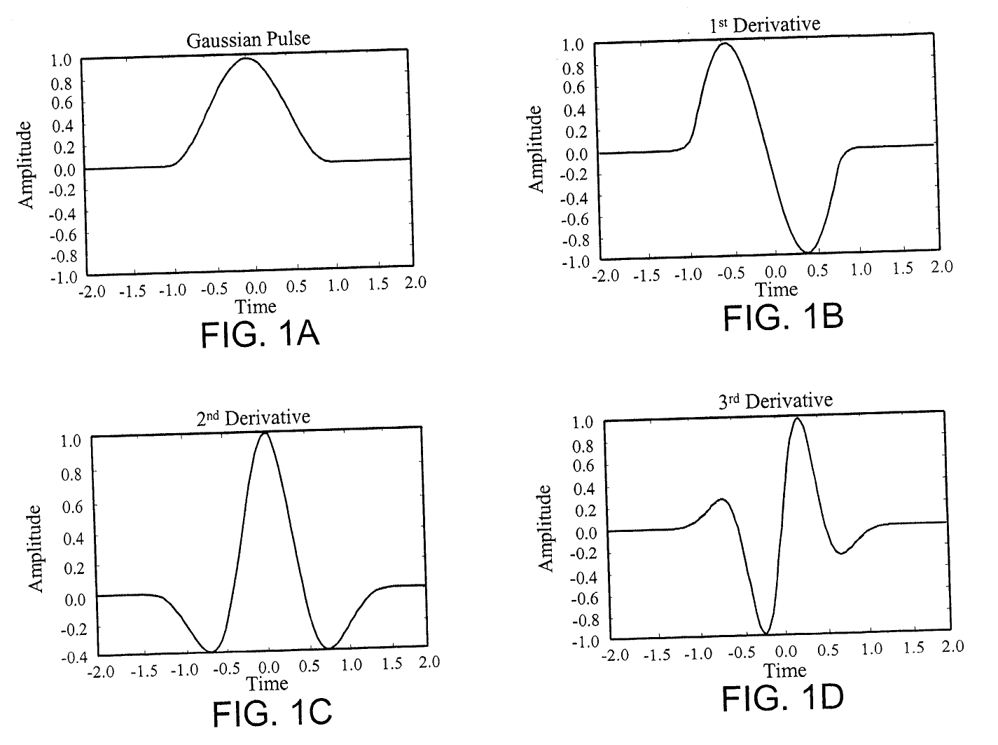

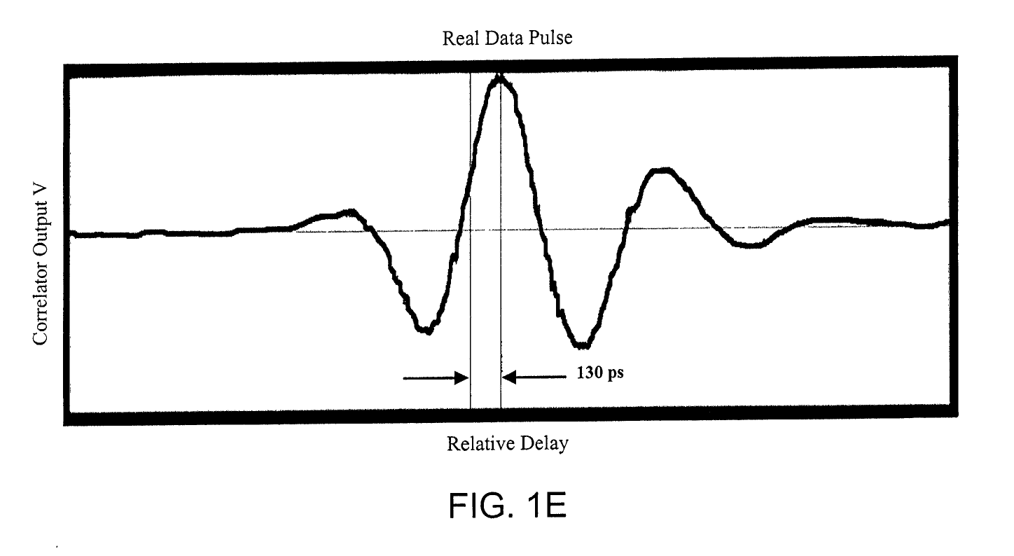

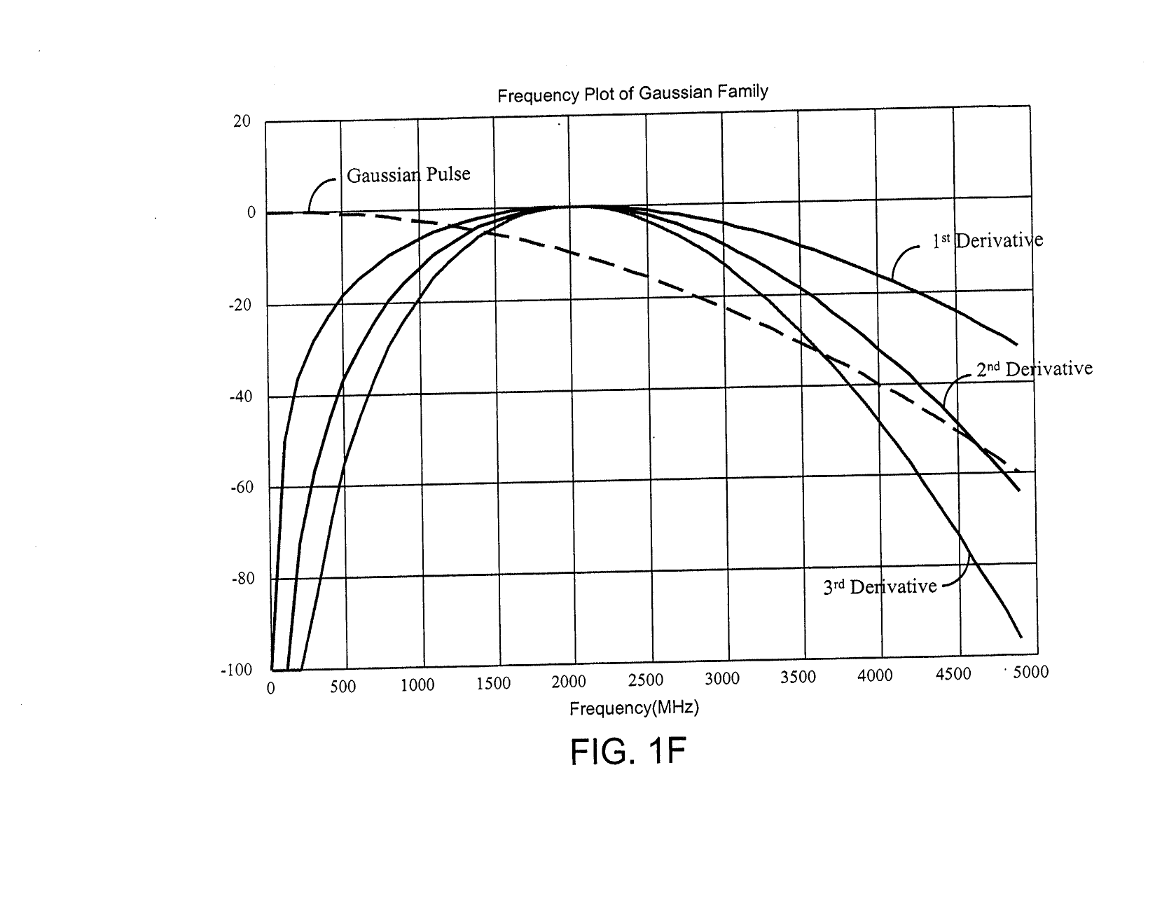

Impulse transmission systems are based on short, low duty-cycle pulses. Different pulse waveforms, or pulse types, may be employed to accommodate requirements of various applications. Typical pulse types include a Gaussian pulse, pulse doublet (also referred to as a Gaussian monocycle), pulse triplet, and pulse quadlet as depicted in FIGS. 1A through 1D, respectively. An actual received waveform that closely resembles the theoretical pulse quadlet is shown in FIG. 1E. A pulse type may also be a wavelet set produced by combining two or more pulse waveforms (e.g., a doublet/triplet wavelet set). These different pulse types may be produced by methods described in the patent documents referenced above or by other methods, as persons skilled in the art would understand.

For analysis purposes, it is convenient to model pulse waveforms in an ideal manner. For example, the transmitted waveform produced by supplying a step function into an ultra-wideband antenna may be modeled as a Gaussian monocycle. A Gaussian monocycle (normalized to a peak value of 1) may be described by:

$${f}_{m o n o} ( t ) = \sqrt{e} ( \frac{t}{σ} ) {ⅇ}^{\frac{- {t}^{2}}{2 {σ}^{2}}}$$

where σ is a time scaling parameter, t is time, and e is the natural logarithm base.

The power special density of the Gaussian monocycle is shown in FIG. 1F, along with spectrums for the Gaussian pulse, triplet, and quadlet. The corresponding equation for the Gaussian monocycle is:

$${F}_{m o n o} ( f ) = {( 2 π )}^{\frac{3}{2}} σ f {ⅇ}^{- 2 {( πσ f )}^{2}}$$

The center frequency (ƒ_{c}) or frequency of peak spectral density, of the Gaussian monocycle is:

$${f}_{c} = \frac{1}{2 πσ}$$

It should be noted that the output of an ultra-wideband antenna is essentially equal to the derivative of its input. Accordingly, since the pulse doublet, pulse triplet, and pulse quadlet are the first, second, and third derivatives of the Gaussian pulse, in an ideal model, an antenna receiving a Gaussian pulse will transmit a Gaussian monocycle and an antenna receiving a Gaussian monocycle will provide a pulse triplet.

Pulse Trains

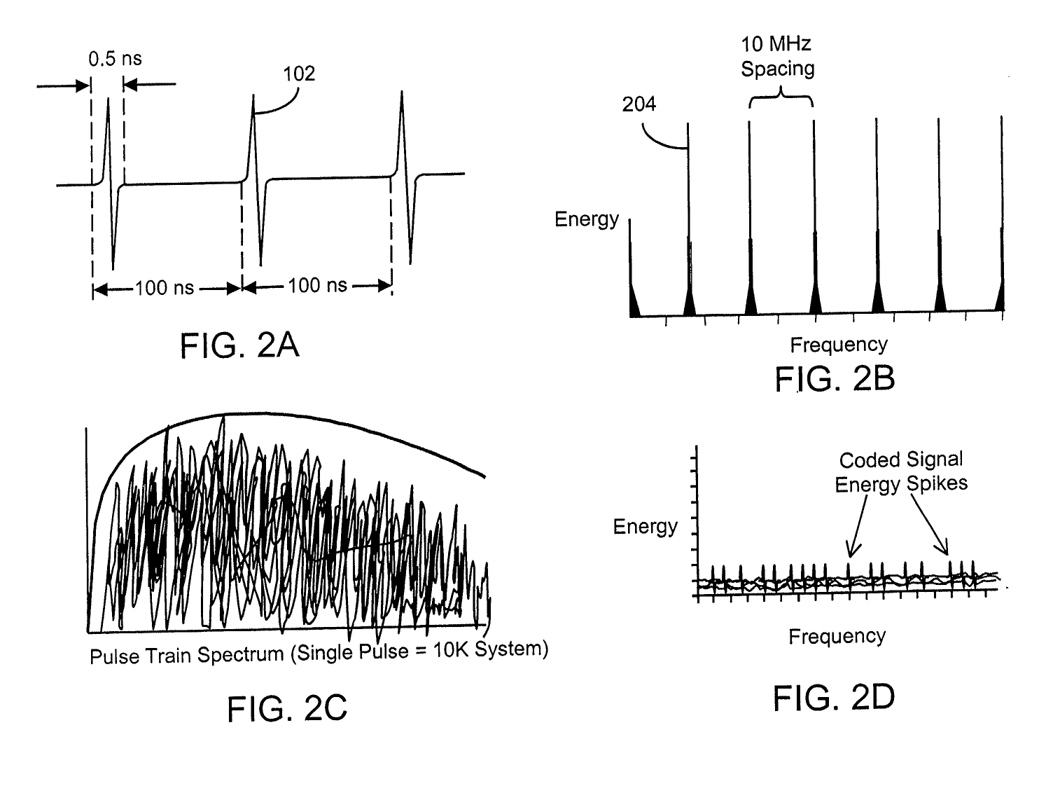

Impulse transmission systems may communicate one or more data bits with a single pulse; however, typically each data bit is communicated using a sequence of pulses, known as a pulse train. As described in detail in the following example system, the impulse radio transmitter produces and outputs a train of pulses for each bit of information. FIGS. 2A and 2B are illustrations of the output of a typical 10 megapulses per second (Mpps) system with uncoded, unmodulated pulses, each having a width of 0.5 nanoseconds (ns). FIG. 2A shows a time domain representation of the pulse train output. FIG. 2B illustrates that the result of the pulse train in the frequency domain is to produce a spectrum comprising a set of comb lines spaced at the frequency of the 10 Mpps pulse repetition rate. When the full spectrum is shown, as in FIG. 2C, the envelope of the comb line spectrum corresponds to the curve of the single Gaussian monocycle spectrum in FIG. 1F. For this simple uncoded case, the power of the pulse train is spread among roughly two hundred comb lines. Each comb line thus has a small fraction of the total power and presents much less of an interference problem to a receiver sharing the band. It can also be observed from FIG. 2A that impulse transmission systems typically have very low average duty cycles, resulting in average power lower than peak power. The duty cycle of the signal in FIG. 2A is 0.5%, based on a 0.5 ns pulse duration in a 100 ns interval.

The signal of an uncoded, unmodulated pulse train may be expressed:

$$s ( t ) = {( - 1 )}^{f} a {\sum }_{j} ω ( c t - j {T}_{f} , b )$$

where j is the index of a pulse within a pulse train, (−1)^{ƒ} is polarity (+/−), a is pulse amplitude, b is pulse type, c is pulse width, ω(t,b) is the normalized pulse waveform, and T_{ƒ} is pulse repetition time.

The energy spectrum of a pulse train signal over a frequency bandwidth of interest may be determined by summing the phasors of the pulses at each frequency, using the following equation:

$$A ( ω ) = \vert {\sum }_{i = 1}^{n} \frac{{ⅇ}^{jΔ t}}{n} \vert$$

where A(ω) is the amplitude of the spectral response at a given frequency, ω is the frequency being analyzed (2πƒ), Δt is the relative time delay of each pulse from the start of time period, and n is the total number of pulses in the pulse train.

A pulse train can also be characterized by its autocorrelation and cross-correlation properties. Autocorrelation properties pertain to the number of pulse coincidences (i.e., simultaneous arrival of pulses) that occur when a pulse train is correlated against an instance of itself that is offset in time. Of primary importance is the ratio of the number of pulses in the pulse train to the maximum number of coincidences that occur for any time offset across the period of the pulse train. This ratio is commonly referred to as the main-lobe-to-side-lobe ratio, where the greater the ratio, the easier it is to acquire and track a signal.

Cross-correlation properties involve the potential for pulses from two different signals simultaneously arriving, or coinciding, at a receiver. Of primary importance are the maximum and average numbers of pulse coincidences that may occur between two pulse trains. As the number of coincidences increases, the propensity for data errors increases. Accordingly, pulse train cross-correlation properties are used in determining channelization capabilities of impulse transmission systems (i.e., the ability to simultaneously operate within close proximity).

Coding

Specialized coding techniques can be employed to specify temporal and/or non-temporal pulse characteristics to produce a pulse train having certain spectral and/or correlation properties. For example, by employing a PN code to vary inter-pulse spacing, the energy in the comb lines presented in FIG. 2B can be distributed to other frequencies as depicted in FIG. 2D, thereby decreasing the peak spectral density within a bandwidth of interest. Note that the spectrum retains certain properties that depend on the specific (temporal) PN code used. Spectral properties can be similarly affected by using non-temporal coding (e.g., inverting certain pulses).

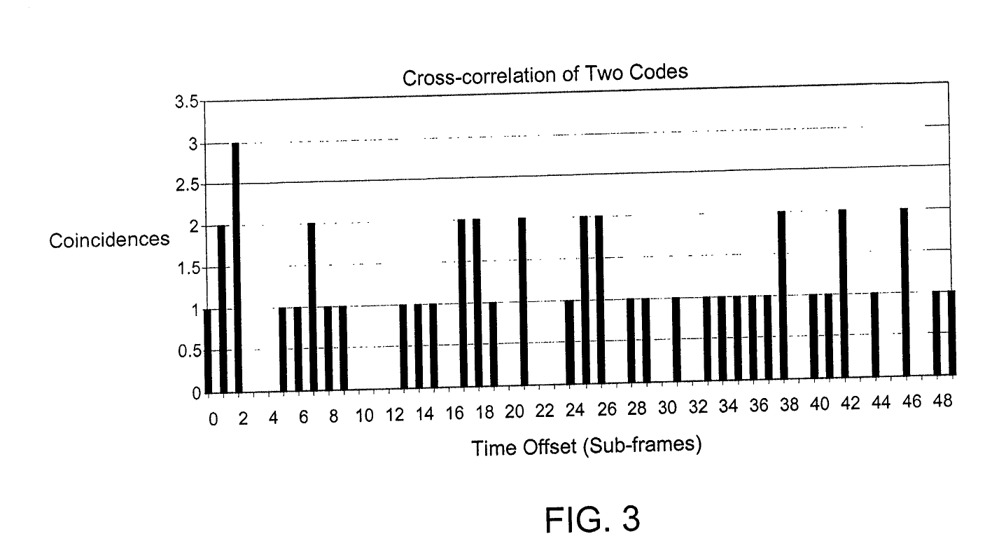

Coding provides a method of establishing independent communication channels. Specifically, families of codes can be designed such that the number of pulse coincidences between pulse trains produced by any two codes will be minimal. For example, FIG. 3 depicts cross-correlation properties of two codes that have no more than four coincidences for any time offset. Generally, keeping the number of pulse collisions minimal represents a substantial attenuation of the unwanted signal.

Coding can also be used to facilitate signal acquisition. For example, coding techniques can be used to produce pulse trains with a desirable main-lobe-to-side-lobe ratio. In addition, coding can be used to reduce acquisition algorithm search space.

Coding methods for specifying temporal and non-temporal pulse characteristics are described in commonly owned, co-pending applications titled “A Method and Apparatus for Positioning Pulses in Time,” application Ser. No. 09/592,249, and “A Method for Specifying Non-Temporal Pulse Characteristics,” application Ser. No. 09/592,250, both filed Jun. 12, 2000, and both of which are incorporated herein by reference.

Typically, a code consists of a number of code elements having integer or floating-point values. A code element value may specify a single pulse characteristic or may be subdivided into multiple components, each specifying a different pulse characteristic. Code element or code component values typically map to a pulse characteristic value layout that may be fixed or non-fixed and may involve value ranges, discrete values, or a combination of value ranges and discrete values. A value range layout specifies a range of values that is divided into components that are each subdivided into subcomponents, which can be further subdivided, as desired. In contrast, a discrete value layout involves uniformly or non-uniformly distributed discrete values. A non-fixed layout (also referred to as a delta layout) involves delta values relative to some reference value. Fixed and non-fixed layouts, and approaches for mapping code element/component values, are described in co-owned, co-pending applications, titled “Method for Specifying Pulse Characteristics using Codes,” application Ser. No. 09/592,290 and “A Method and Apparatus for Mapping Pulses to a Non-Fixed Layout,” application Ser. No. 09/591,691, both filed on Jun. 12, 2000, both of which are incorporated herein by reference.

A fixed or non-fixed characteristic value layout may include a non-allowable region within which a pulse characteristic value is disallowed. A method for specifying non-allowable regions is described in co-owned, co-pending application titled “A Method for Specifying Non-Allowable Pulse Characteristics,” application Ser. No. 09/592,289, filed Jun. 12, 2000, and incorporated herein by reference. A related method that conditionally positions pulses depending on whether code elements map to non-allowable regions is described in co-owned, co-pending application, titled “A Method and Apparatus for Positioning Pulses Using a Layout having Non-Allowable Regions,” application Ser. No. 09/592,248 filed Jun. 12, 2000, and incorporated herein by reference.

The signal of a coded pulse train can be generally expressed by:

$${s}_{t r}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)ƒⱼ^{(k)}, aⱼ^{(k)}, bⱼ^{(k)}, cⱼ^{(k)}, and ω(t,bⱼ^{(k)}) are the coded polarity, pulse amplitude, pulse type, pulse width, and normalized pulse waveform of the jth pulse of the kth transmitter, and Tⱼ^{(k)} is the coded time shift of the jth pulse of the kth transmitter. Note: When a given non-temporal characteristic does not vary (i.e., remains constant for all pulses), it becomes a constant in front of the summation sign.

Various numerical code generation methods can be employed to produce codes having certain correlation and spectral properties. Such codes typically fall into one of two categories: designed codes and pseudorandom codes. A designed code may be generated using a quadratic congruential, hyperbolic congruential, linear congruential, Costas array, or other such numerical code generation technique designed to generate codes having certain correlation propertis. A pseudorandom code may be generated using a computer's random number generator, binary shift-register(s) mapped to binary words, a chaotic code generation scheme, or the like. Such ‘random-like’ codes are attractive for certain applications since they tend to spread spectral energy over multiple frequencies while having ‘good enough’ correlation properties, whereas designed codes may have superior correlation properties but possess less suitable spectral properties. Detailed descriptions of numerical code generation techniques are included in a co-owned, co-pending patent application titled “A Method and Apparatus for Positioning Pulses in Time,” application Ser. No. 09/592,248, filed Jun. 12, 2000, and incorporated herein by reference.

It may be necessary to apply predefined criteria to determine whether a generated code, code family, or a subset of a code is acceptable for use with a given UWB application. Criteria may include correlation properties, spectral properties, code length, non-allowable regions, number of code family members, or other pulse characteristics. A method for applying predefined criteria to codes is described in co-owned, co-pending application, titled “A Method and Apparatus for Specifying Pulse Characteristics using a Code that Satisfies Predefined Criteria,” application Ser. No. 09/592,288, filed Jun. 12, 2000, and incorporated herein by reference.

In some applications, it may be desirable to employ a combination of codes. Codes may be combined sequentially, nested, or sequentially nested, and code combinations may be repeated. Sequential code combinations typically involve switching from one code to the next after the occurrence of some event and may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in particular spectral properties. A method for applying code combinations is described in co-owned, co-pending application, titled “A Method and Apparatus for Applying Codes Having Pre-Defined Properties,” application Ser. No. 09/591,690, filed Jun. 12, 2000, and incorporated herein by reference.

Modulation

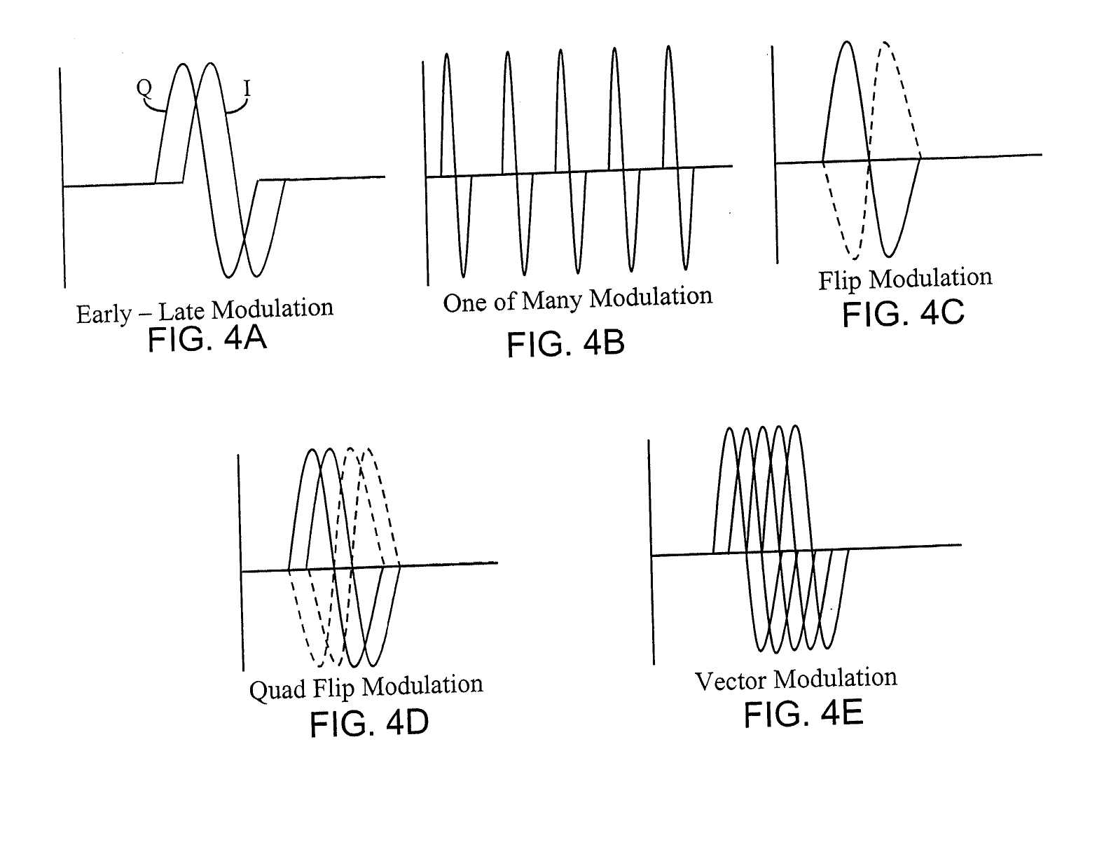

Various aspects of a pulse waveform may be modulated to convey information and to further minimize structure in the resulting spectrum. Amplitude modulation, phase modulation, frequency modulation, time-shift modulation and M-ary versions of these were proposed in U.S. Pat. No. 5,677,927 to Fullerton et al., previously incorporated by reference. Time-shift modulation can be described as shifting the position of a pulse either forward or backward in time relative to a nominal coded (or uncoded) time position in response to an information signal. Thus, each pulse in a train of pulses is typically delayed a different amount from its respective time base clock position by an individual code delay amount plus a modulation time shift. This modulation time shift is normally very small relative to the code shift. In a 10 Mpps system with a center frequency of 2 GHz, for example, the code may command pulse position variations over a range of 100 ns, whereas, the information modulation may shift the pulse position by 150 ps. This two-state ‘early-late’ form of time shift modulation is depicted in FIG. 4A.

A pulse train with conventional ‘early-late’ time-shift modulation can be expressed:

$${s}_{t r}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} - δ {d}_{[ j / {N}_{s} ]}^{( k )} , {b}_{j}^{( k )} )$$

where k is the index of a transmitter, j is the index of a pulse within its pulse train, (−1)ƒⱼ^{(k)}, aⱼ^{(k)}, b^{j}^{(k)}, cⱼ^{(k)}, and ω(t,bⱼ^{(k)}) are the coded polarity, pulse amplitude, pulse type, pulse width, and normalized pulse waveform of the jth pulse of the kth transmitter, Tⱼ^{(k)} is the coded time shift of the jth pulse of the kth transmitter, δ is the time shift added when the transmitted symbol is 1 (instead of 0), d^{(k)} is the data (i.e., 0 or 1) transmitted by the kth transmitter, and Nₛ is the number of pulses per symbol (e.g., bit). Similar expressions can be derived to accommodate other proposed forms of modulation.

An alternative form of time-shift modulation can be described as One-of-Many Position Modulation (OMPM). The OMPM approach, shown in FIG. 4B, involves shifting a pulse to one of N possible modulation positions about a nominal coded (or uncoded) time position in response to an information signal, where N represents the number of possible states. For example, if N were four (4), two data bits of information could be conveyed. For further details regarding OMPM, see “Apparatus, System and Method for One-of-Many Position Modulation in an Impulse Radio Communication System,” Attorney Docket No. 1659.0860000, filed Jun. 7, 2000, assigned to the assignee of the present invention, and incorporated herein by reference.

An impulse radio communications system can employ flip modulation techniques to convey information. The simplest flip modulation technique involves transmission of a pulse or an inverted (or flipped) pulse to represent a data bit of information, as depicted in FIG. 4C. Flip modulation techniques may also be combined with time-shift modulation techniques to create two, four, or more different data states. One such flip with shift modulation technique is referred to as Quadrature Flip Time Modulation (QFTM). The QFTM approach is illustrated in FIG. 4D. Flip modulation techniques are further described in patent application titled “Apparatus, System and Method for Flip Modulation in an Impulse Radio Communication System,” application Ser. No. 09/537,692, filed Mar. 29, 2000, assigned to the assignee of the present invention, and incorporated herein by reference.

Vector modulation techniques may also be used to convey information. Vector modulation includes the steps of generating and transmitting a series of time-modulated pulses, each pulse delayed by one of at least four pre-determined time delay periods and representative of at least two data bits of information, and receiving and demodulating the series of time-modulated pulses to estimate the data bits associated with each pulse. Vector modulation is shown in FIG. 4E. Vector modulation techniques are further described in patent application titled “Vector Modulation System and Method for Wideband Impulse Radio Communications,” application Ser. No. 09/169,765, filed Dec. 9, 1999, assigned to the assignee of the present invention, and incorporated herein by reference.

Reception and Demodulation

Impulse radio systems operating within close proximity to each other may cause mutual interference. While coding minimizes mutual interference, the probability of pulse collisions increases as the number of coexisting impulse radio systems rises. Additionally, various other signals may be present that cause interference. Impulse radios can operate in the presence of mutual interference and other interfering signals, in part because they do not depend on receiving every transmitted pulse. Impulse radio receivers perform a correlating, synchronous receiving function (at the RF level) that uses statistical sampling and combining, or integration, of many pulses to recover transmitted information. Typically, 1 to 1000 or more pulses are integrated to yield a single data bit thus diminishing the impact of individual pulse collisions, where the number of pulses that must be integrated to successfully recover transmitted information depends on a number of variables including pulse rate, bit rate, range and interference levels.

Interference Resistance

Besides providing channelization and energy smoothing, coding makes impulse radios highly resistant to interference by enabling discrimination between intended impulse transmissions and interfering transmissions. This property is desirable since impulse radio systems must share the energy spectrum with conventional radio systems and with other impulse radio systems.

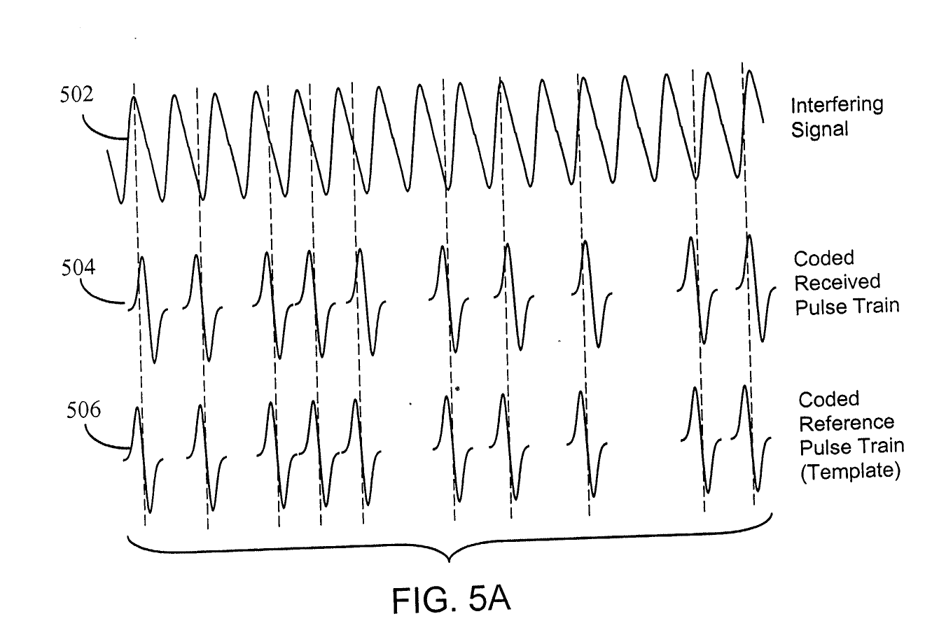

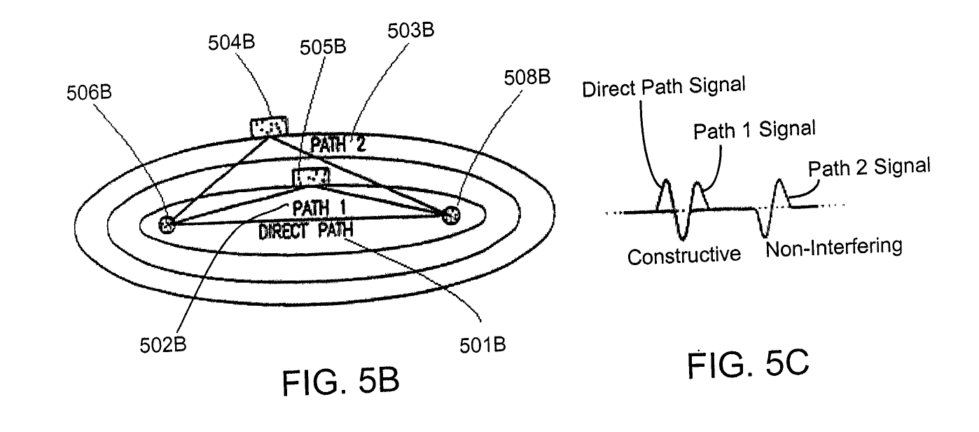

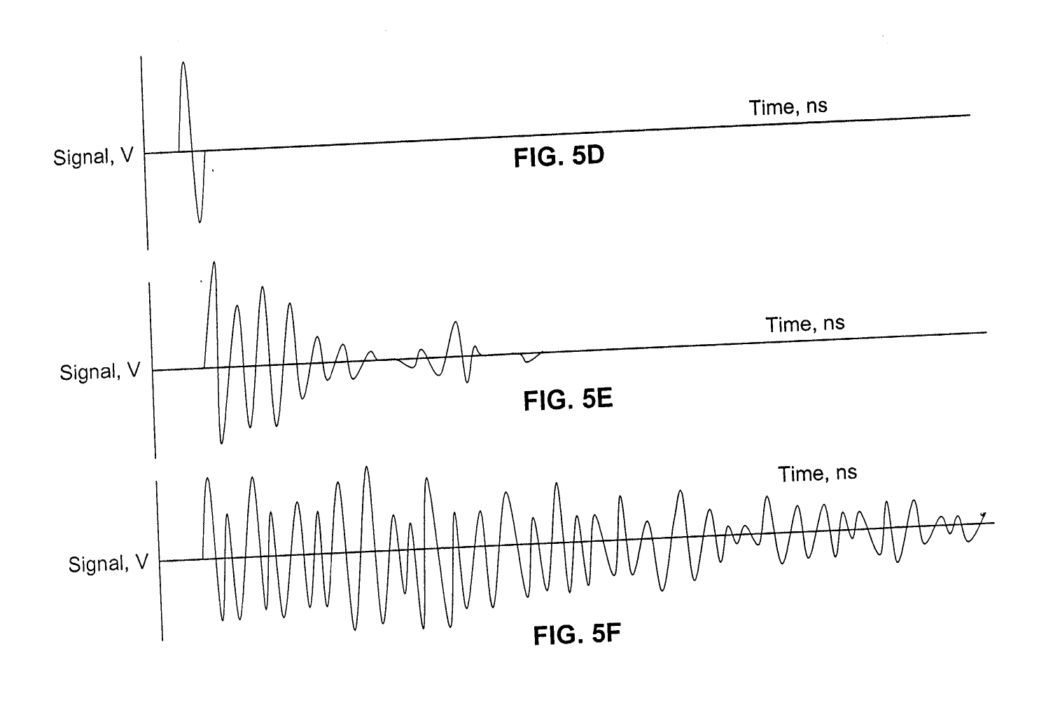

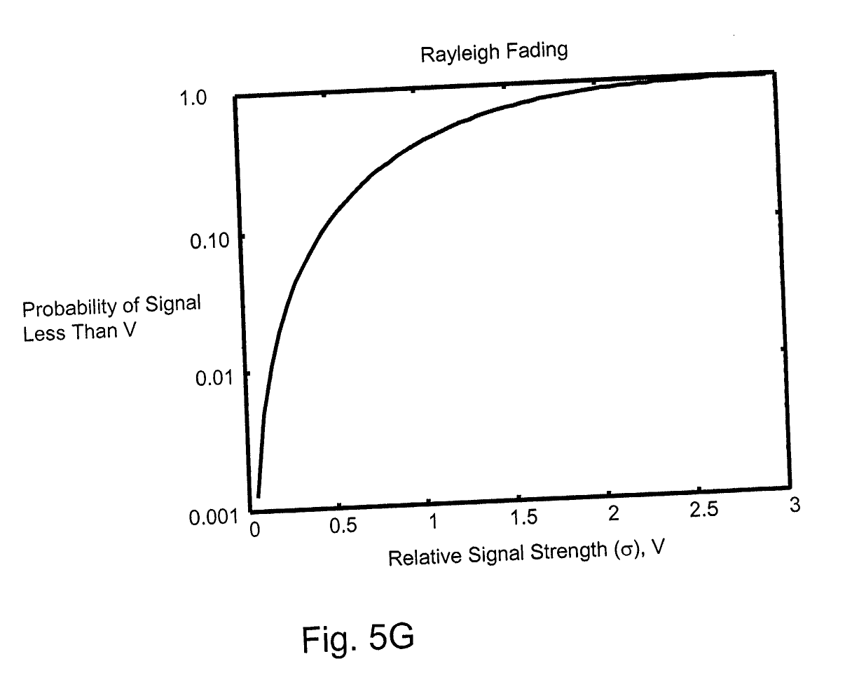

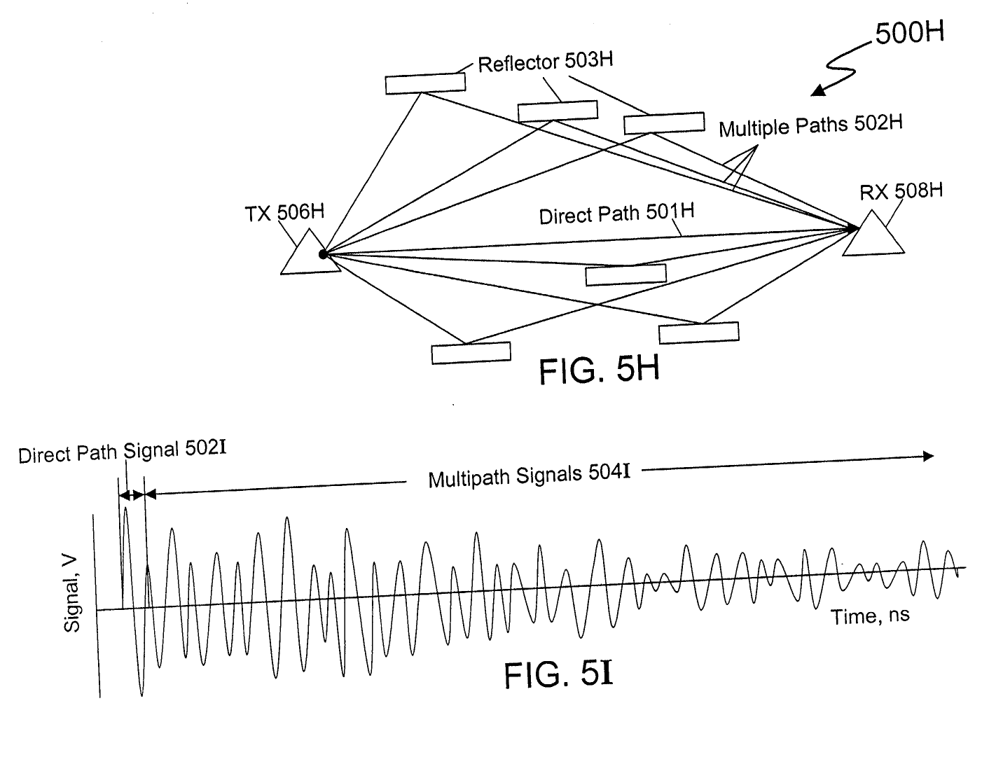

FIG. 5A illustrates the result of a narrow band sinusoidal interference signal 502 overlaying an impulse radio signal 504. At the impulse radio receiver, the input to the cross correlation would include the narrow band signal 502 and the received ultra wide-band impulse radio signal 504. The input is sampled by the cross correlator using a template signal 506 positioned in accordance with a code. Without coding, the cross correlation would sample the interfering signal 502 with such regularity that the interfering signals could cause interference to the impulse radio receiver. However, when the transmitted impulse signal is coded and the impulse radio receiver template signal 506 is synchronized using the identical code, the receiver samples the interfering signals non-uniformly. The samples from the interfering signal add incoherently, increasing roughly according to the square root of the number of samples integrated. The impulse radio signal samples, however, add coherently, increasing directly according to the number of samples integrated. Thus, integrating over many pulses overcomes the impact of interference.

Processing Gain

Impulse radio systems have exceptional processing gain due to their wide spreading bandwidth. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000, or 30 dB. However, far greater processing gains are achieved by impulse radio systems, where the same 10 KHz information bandwidth is spread across a much greater 2 GHz channel bandwidth, resulting in a theoretical processing gain of 200,000, or 53 dB.

Capacity

It can be shown theoretically, using signal-to-noise arguments, that thousands of simultaneous channels are available to an impulse radio system as a result of its exceptional processing gain.

The average output signal-to-noise ratio of the impulse radio may be calculated for randomly selected time-hopping codes as a function of the number of active users, Nᵤ, as:

where Nₛ is the number of pulses integrated per bit of information, Aₖ models the attenuation of transmitter k's signal over the propagation path to the receiver, and σ_{rec}² is the variance of the receiver noise component at the pulse train integrator output. The monocycle waveform-dependent parameters mₚ and σₐ² are given by

$${m}_{p} = {\int }_{- ∞}^{∞} ω ( t ) [ ω ( t ) - ω ( t - δ ) ] ⅆ t$$

$$a n d$$

$${σ}_{a}^{2} = {T}_{f}^{- 1} {\int }_{- ∞}^{∞} {[ {\int }_{- ∞}^{∞} ω ( t - s ) υ ( t ) ⅆ t ]}^{2} ⅆ s ,$$

where ω(t) is the monocycle waveform, υ(t)=ω(t)−ω(t−δ) is the template signal waveform, δ is the time shift between the monocycle waveform and the template signal waveform, T_{ƒ} is the pulse repetition time, and s is signal.

Multipath and Propagation

One of the advantages of impulse radio is its resistance to multipath fading effects. Conventional narrow band systems are subject to multipath through the Rayleigh fading process, where the signals from many delayed reflections combine at the receiver antenna according to their seemingly random relative phases resulting in possible summation or possible cancellation, depending on the specific propagation to a given location. Multipath fading effects are most adverse where a direct path signal is weak relative to multipath signals, which represents the majority of the potential coverage area of a radio system. In a mobile system, received signal strength fluctuates due to the changing mix of multipath signals that vary as its position varies relative to fixed transmitters, mobile transmitters and signal-reflecting surfaces in the environment.

Impulse radios, however, can be substantially resistant to multipath effects. Impulses arriving from delayed multipath reflections typically arrive outside of the correlation time and, thus, may be ignored. This process is described in detail with reference to FIGS. 5B and 5C. FIG. 5B illustrates a typical multipath situation, such as in a building, where there are many reflectors 504B, 505B. In this figure, a transmitter 506B transmits a signal that propagates along three paths, the direct path 501B, path 1 502B, and path2 503B, to a receiver 508B, where the multiple reflected signals are combined at the antenna. The direct path 501B, representing the straight-line distance between the transmitter and receiver, is the shortest. Path 1 502B represents a multipath reflection with a distance very close to that of the direct path. Path 2 503B represents a multipath reflection with a much longer distance. Also shown are elliptical (or, in space, ellipsoidal) traces that represent other possible locations for reflectors that would produce paths having the same distance and thus the same time delay.

FIG. 5C illustrates the received composite pulse waveform resulting from the three propagation paths 501B, 502B, and 503B shown in FIG. 5B. In this figure, the direct path signal 501 B is shown as the first pulse signal received. The path 1 and path 2 signals 502B, 503B comprise the remaining multipath signals, or multipath response, as illustrated. The direct path signal is the reference signal and represents the shortest propagation time. The path 1 signal is delayed slightly and overlaps and enhances the signal strength at this delay value. The path 2 signal is delayed sufficiently that the waveform is completely separated from the direct path signal. Note that the reflected waves are reversed in polarity. If the correlator template signal is positioned such that it will sample the direct path signal, the path 2 signal will not be sampled and thus will produce no response. However, it can be seen that the path 1 signal has an effect on the reception of the direct path signal since a portion of it would also be sampled by the template signal. Generally, multipath signals delayed less than one quarter wave (one quarter wave is about 1.5 inches, or 3.5 cm at 2 GHz center frequency) may attenuate the direct path signal. This region is equivalent to the first Fresnel zone in narrow band systems. Impulse radio, however, has no further nulls in the higher Fresnel zones. This ability to avoid the highly variable attenuation from multipath gives impulse radio significant performance advantages.

FIGS. 5D, 5E, and 5F represent the received signal from a TM-UWB transmitter in three different multipath environments. These figures are approximations of typical signal plots. FIG. 5D illustrates the received signal in a very low multipath environment. This may occur in a building where the receiver antenna is in the middle of a room and is a relatively short, distance, for example, one meter, from the transmitter. This may also represent signals received from a larger distance, such as 100 meters, in an open field where there are no objects to produce reflections. In this situation, the predominant pulse is the first received pulse and the multipath reflections are too weak to be significant. FIG. 5E illustrates an intermediate multipath environment. This approximates the response from one room to the next in a building. The amplitude of the direct path signal is less than in FIG. 5D and several reflected signals are of significant amplitude. FIG. 5F approximates the response in a severe multipath environment such as propagation through many rooms, from corner to corner in a building, within a metal cargo hold of a ship, within a metal truck trailer, or within an intermodal shipping container. In this scenario, the main path signal is weaker than in FIG. 5E. In this situation, the direct path signal power is small relative to the total signal power from the reflections.

An impulse radio receiver can receive the signal and demodulate the information using either the direct path signal or any multipath signal peak having sufficient signal-to-noise ratio. Thus, the impulse radio receiver can select the strongest response from among the many arriving signals. In order for the multipath signals to cancel and produce a null at a given location, dozens of reflections would have to be cancelled simultaneously and precisely while blocking the direct path, which is a highly unlikely scenario. This time separation of mulitipath signals together with time resolution and selection by the receiver permit a type of time diversity that virtually eliminates cancellation of the signal. In a multiple correlator rake receiver, performance is further improved by collecting the signal power from multiple signal peaks for additional signal-to-noise performance.

Where the system of FIG. 5B is a narrow band system and the delays are small relative to the data bit time, the received signal is a sum of a large number of sine waves of random amplitude and phase. In the idealized limit, the resulting envelope amplitude has been shown to follow a Rayleigh probability distribution as follows:

$$p ( r ) = \frac{r}{{σ}^{2}} exp ( \frac{- {r}^{2}}{2 {σ}^{2}} )$$

where r is the envelope amplitude of the combined multipath signals, and σ(2)^{1/2} is the RMS power of the combined multipath signals. The Rayleigh distribution curve in FIG. 5G shows that 10% of the time, the signal is more than 10 dB attenuated. This suggests that 10 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in an urban canyon or other situations where the propagation is such that the received signal is primarily scattered energy, impulse radio systems can avoid the Rayleigh fading mechanism that limits performance of narrow band systems, as illustrated in FIGS. 5H and 5I. FIG. 5H depicts an impulse radio system in a high multipath environment 500H consisting of a transmitter 506H and a receiver 508H. A transmitted signal follows a direct path 501H and reflects off reflectors 503H via multiple paths 502H. FIG. 5I illustrates the combined signal received by the receiver 508H over time with the vertical axis being signal strength in volts and the horizontal axis representing time in nanoseconds. The direct path 501H results in the direct path signal 502I while the multiple paths 502H result in multipath signals 504I. In the same manner described earlier for FIGS. 5B and 5C, the direct path signal 502I is sampled, while the multipath signals 504I are not, resulting in Rayleigh fading avoidance.

Distance Measurement and Positioning

Impulse systems can measure distances to relatively fine resolution because of the absence of ambiguous cycles in the received waveform. Narrow band systems, on the other hand, are limited to the modulation envelope and cannot easily distinguish precisely which RF cycle is associated with each data bit because the cycle-to-cycle amplitude differences are so small they are masked by link or system noise. Since an impulse radio waveform has no multi-cycle ambiguity, it is possible to determine waveform position to less than a wavelength, potentially down to the noise floor of the system. This time position measurement can be used to measure propagation delay to determine link distance to a high degree of precision. For example, 30 ps of time transfer resolution corresponds to approximately centimeter distance resolution. See, for example, U.S. Pat. No. 6,133,876, issued Oct. 17, 2000, titled “System and Method for Position Determination by Impulse Radio,” and U.S. Pat. No. 6,111,536, issued Aug. 29, 2000, titled “System and Method for Distance Measurement by Inphase and Quadrature Signals in a Radio System,” both of which are incorporated herein by reference.

In addition to the methods articulated above, impulse radio technology along with Time Division Multiple Access algorithms and Time Domain packet radios can achieve geo-positioning capabilities in a radio network. This geo-positioning method is described in co-owned, co-pending application titled “System and Method for Person or Object Position Location Utilizing Impulse Radio,” application Ser. No. 09/456,409, filed Dec. 8, 1999, and incorporated herein by reference.

Power Control

Power control systems comprise a first transceiver that transmits an impulse radio signal to a second transceiver. A power control update is calculated according to a performance measurement of the signal received at the second transceiver. The transmitter power of either transceiver, depending on the particular setup, is adjusted according to the power control update. Various performance measurements are employed to calculate a power control update, including bit error rate, signal-to-noise ratio, and received signal strength, used alone or in combination. Interference is thereby reduced, which may improve performance where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of impulse radio power control, see patent application titled “System and Method for Impulse Radio Power Control,” application Ser. No. 09/332,501, filed Jun. 14, 1999, assigned to the assignee of the present invention, and incorporated herein by reference.

Mitigating Effects of Interference

A method for mitigating interference in impulse radio systems comprises the steps of conveying the message in packets, repeating conveyance of selected packets to make up a repeat package, and conveying the repeat package a plurality of times at a repeat period greater than twice the period of occurrence of the interference. The communication may convey a message from a proximate transmitter to a distal receiver, and receive a message by a proximate receiver from a distal transmitter. In such a system, the method comprises the steps of providing interference indications by the distal receiver to the proximate transmitter, using the interference indications to determine predicted noise periods, and operating the proximate transmitter to convey the message according to at least one of the following: (1) avoiding conveying the message during noise periods, (2) conveying the message at a higher power during noise periods, (3) increasing error detection coding in the message during noise periods, (4) re-transmitting the message following noise periods, (5) avoiding conveying the message when interference is greater than a first strength, (6) conveying the message at a higher power when the interference is greater than a second strength, (7) increasing error detection coding in the message when the interference is greater than a third strength, and (8) re-transmitting a portion of the message after interference has subsided to less than a predetermined strength.

For greater elaboration of mitigating interference in impulse radio systems, see the patent application titled “Method for Mitigating Effects of Interference in Impulse Radio Communication,” application Ser. No. 09/587,033, filed Jun. 2, 1999, assigned to the assignee of the present invention, and incorporated herein by reference.

Moderating Interference in Equipment Control Applications

Yet another improvement to impulse radio includes moderating interference with impulse radio wireless control of an appliance. The control is affected by a controller remote from the appliance which transmits impulse radio digital control signals to the appliance. The control signals have a transmission power and a data rate. The method comprises the steps of establishing a maximum acceptable noise value for a parameter relating to interfering signals and a frequency range for measuring the interfering signals, measuring the parameter for the interference signals within the frequency range, and effecting an alteration of transmission of the control signals when the parameter exceeds the maximum acceptable noise value.

For greater elaboration of moderating interference while effecting impulse radio wireless control of equipment, see patent application titled “Method and Apparatus for Moderating Interference While Effecting Impulse Radio Wireless Control of Equipment,” application Ser. No. 09/586,163, filed Jun. 2, 1999, and assigned to the assignee of the present invention, and incorporated herein by reference.

Exemplary Transceiver Implementation

Transmitter

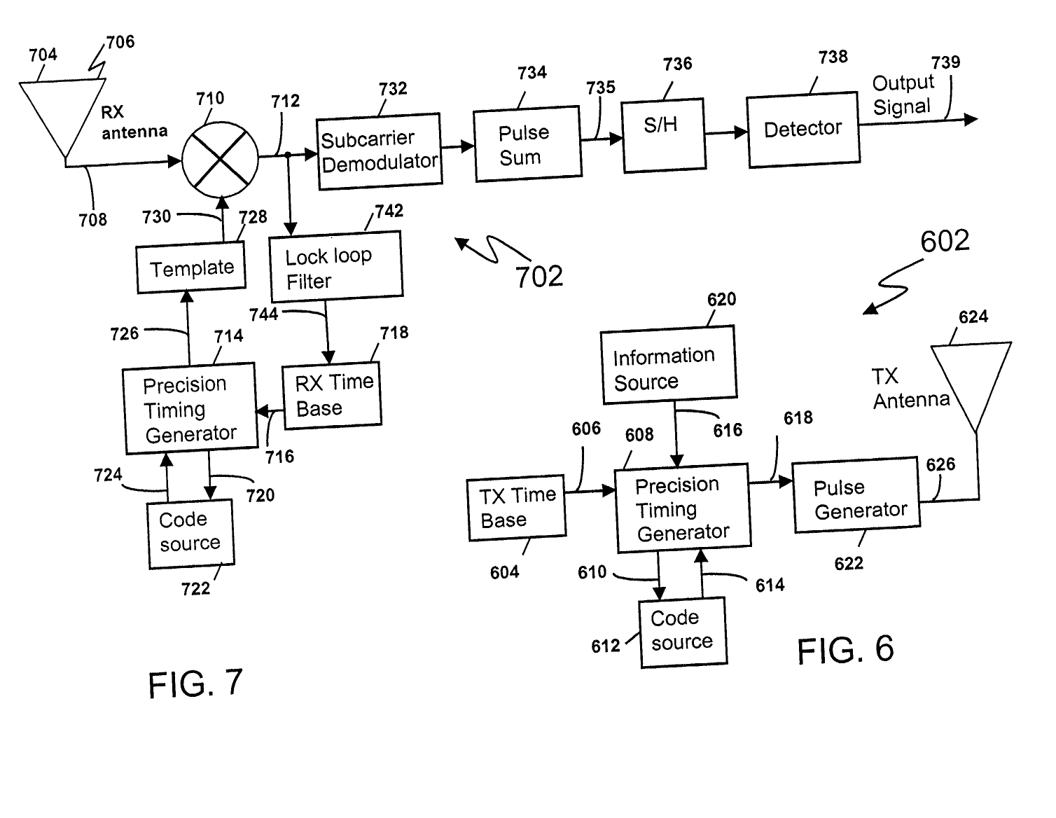

An exemplary embodiment of an impulse radio transmitter 602 of an impulse radio communication system having an optional subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The control voltage to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614, together with an optional, internally generated subcarrier signal, and an information signal 616, to generate a modulated, coded timing signal 618.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger signal to generate output pulses. The output pulses are provided to a transmit antenna 624 via a transmission line 626 coupled thereto. The output pulses are converted into propagating electromagnetic pulses by the transmit antenna 624. The electromagnetic pulses are called the emitted signal, and propagate to an impulse radio receiver 702, such as shown in FIG. 7, through a propagation medium. In a preferred embodiment, the emitted signal is wide-band or ultrawide-band, approaching a monocycle pulse as in FIG. 1B. However, the emitted signal may be spectrally modified by filtering of the pulses, which may cause them to have more zero crossings (more cycles) in the time domain, requiring the radio receiver to use a similar waveform as the template signal for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710, via a receiver transmission line, coupled to the receive antenna 704. The cross correlation 710 produces a baseband output 712.

The receiver 702 also includes a precision timing generator 714, which receives a periodic timing signal 716 from a receiver time base 718. This time base 718 may be adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 preferably comprises a multiplier followed by a short term integrator to sum the multiplier product over the pulse interval.

The output of the correlator 710 is coupled to a subcarrier demodulator 732, which demodulates the subcarrier information signal from the optional subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to provide an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to generate an error signal 744. The error signal 744 provides adjustments to the adjustable time base 718 to position in time the periodic timing signal 726 in relation to the position of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

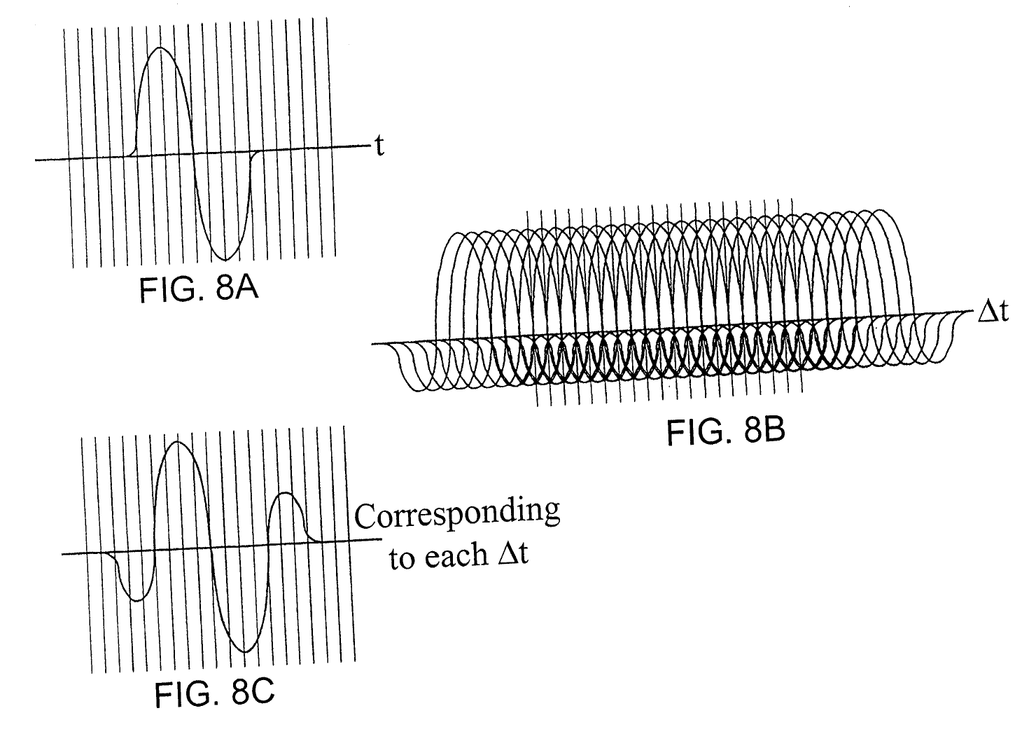

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the cross correlator for each of the time offsets of FIG. 8B. For any given pulse received, there is a corresponding point that is applicable on this graph. This is the point corresponding to the time offset of the template signal used to receive that pulse. Further examples and details of precision timing can be found described in U.S. Pat. No. 5,677,927, and commonly owned co-pending application application Ser. No. 09/146,524, filed Sep. 3, 1998, titled “Precision Timing Generator System and Method,” both of which are incorporated herein by reference.

Because of the unique nature of impulse radio receivers, several modifications have been recently made to enhance system capabilities. Modifications include the utilization of multiple correlators to measure the impulse response of a channel to the maximum communications range of the system and to capture information on data symbol statistics . Further, multiple correlators enable rake pulse correlation techniques, more efficient acquisition and tracking implementations, various modulation schemes, and collection of time-calibrated pictures of received waveforms. For greater elaboration of multiple correlator techniques, see patent application titled “System and Method of using Multiple Correlator Receivers in an Impulse Radio System”, application Ser. No. 09/537,264, filed Mar. 29, 2000, assigned to the assignee of the present invention, and incorporated herein by reference.

Methods to improve the speed at which a receiver can acquire and lock onto an incoming impulse radio signal have been developed. In one approach, a receiver includes an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in more detail in U.S. Pat. No. 5,832,035 to Fullerton, incorporated herein by reference.

In another approach, a receiver obtains a template pulse train and a received impulse radio signal. The receiver compares the template pulse train and the received impulse radio signal. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, see the patent application titled “Method and System for Fast Acquisition of Ultra Wideband Signals,” application Ser. No. 09/538,292, filed Mar. 29, 2000, assigned to the assignee of the present invention, and incorporated herein by reference.

A receiver has been developed that includes a baseband signal converter device and combines multiple converter circuits and an RF amplifier in a single integrated circuit package. For greater elaboration of this receiver, see the patent application titled “Baseband Signal Converter for a Wideband Impulse Radio Receiver,” application Ser. No. 09/356,384, filed Jul. 16, 1999, assigned to the assignee of the present invention, and incorporated herein by reference.

Impulse Radio as Used in the Present Invention

Description of the Preferred Embodiments

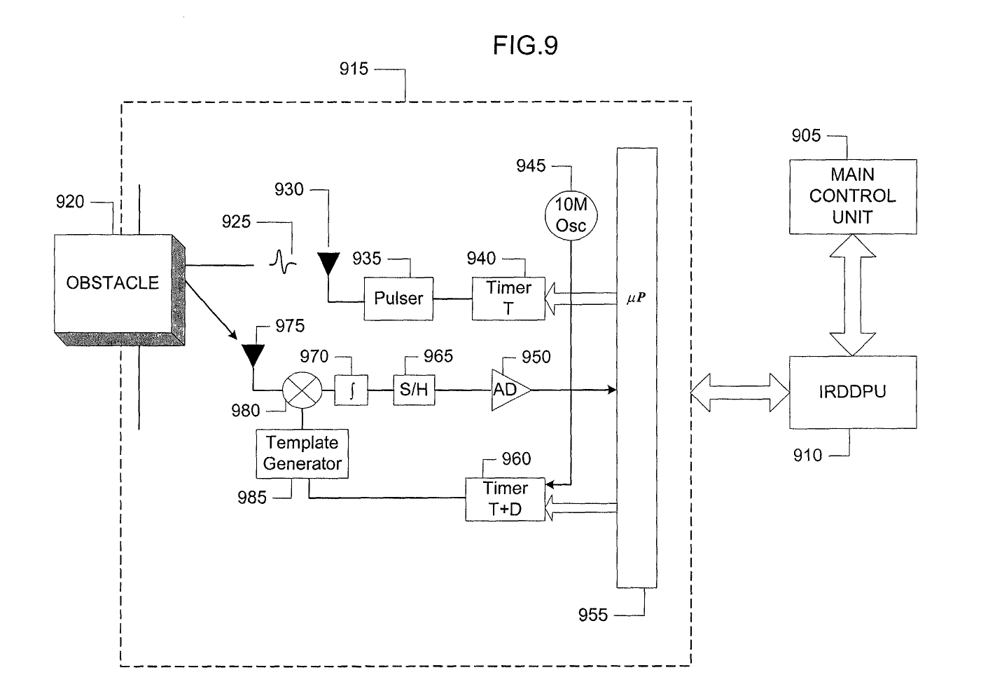

Embodiments of the present invention will now be described with reference to the drawings. As shown in FIG. 9, the system of the present invention comprises a main control unit 905 and at least one, and preferably several, impulse radio distance determination processing units (IRDDPU) 910. These IRDDPUs calculate distance as described below and in detail above and in the patents and patent applications incorporated herein by reference.

In communication with the IRDDPU is the impulse radio radar which includes a microprocessor 955 in communication with timer 960 and timer 945. Also, in communication with and driving timer 960 is a 110 Mhz oscillator. Timer 960 drives template generator 985 which provides a matching template signal to multiply at 980 with an incoming signal from antenna 975. The input signal into antenna 970 is a reflected signal off obstacle 920. The multiplied signal 970 is integrated in integrator 970 and then passes to a sample and hold device at 965 and follows to an analog to digital converter 950, which in turn passes the digital signal for processing at processor 955.

Outputoftimer940 is inputtopulser935, which drives antenna 930. The impulse radio signal propagates through the ether in anticipation of reflection from obstacle 920. Again, more detailed operation of the impulse radio radar is described above and in the Impulse Radio patents and patent applications incorporated herein by reference. Further, the impulse radio radar is not limited to the embodiment shown herein as numerous derivations and modifications to the impulse radio radar are described in the patents and patent applications incorporated herein by reference and the embodiment described immediately above is but one of those embodiments.

Each individual impulse radio radar unit 915 measures the distance to objects in its sensing direction through impulse radio radar techniques described above and sends that information to IRDDPU 910.

In the preferred embodiment of the invention the time-of-flight is determined for pulses that are returned within a range gate from the initiation of the transmitted pulse. For return signals of greater time delays, the range gate is set to an arbitrarily high value, effectively indicating no collision when interpreted by system algorithms. Since the speed of light is approximately 1 foot per nanosecond, this effectively limits the unit of the preferred embodiment to a sensing distance of four feet. Advantageously, in the return signal range gate, the number of pulses that are integrated are averaged.

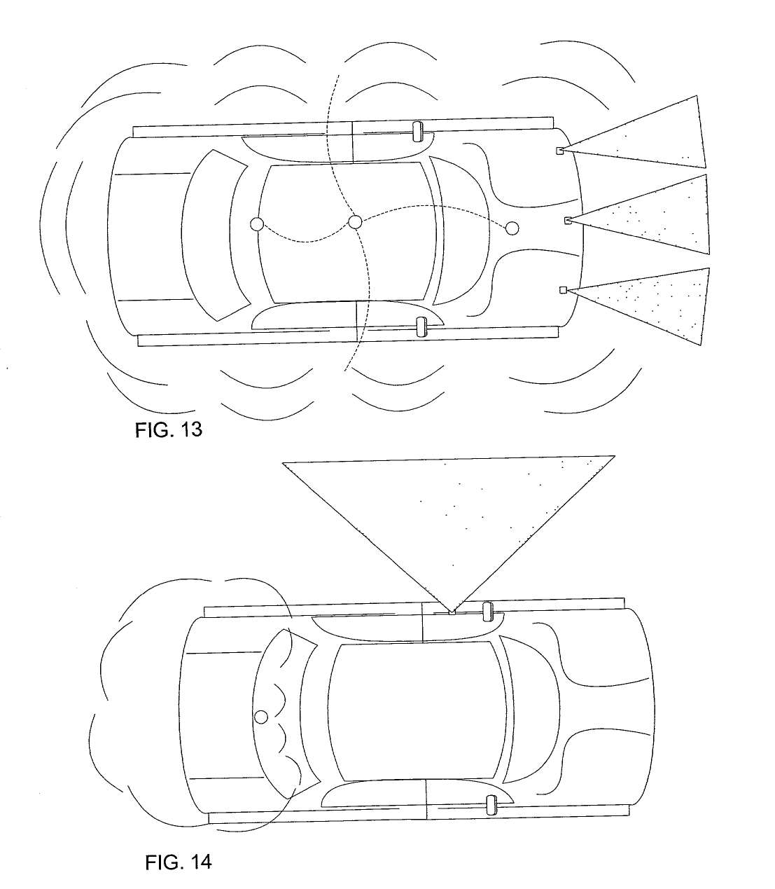

Preferably, the sensing distance should be in the range of about two to six feet and preferably about four feet. In addition to range gating, impulse radios can be directed and steered. Thus, several different embodiments are anticipated wherein a large number of narrow beam width impulse radio radars are positioned throughout the car or in the alternate and wide beam can be used in a dome type fashion to, in essence, create a dome of protection surrounding the vehicle. Both of these are depicted in FIG. 13 and FIG. 14 below.

The time/distance determination in the IRDDPU 910 constitutes the basic measured parameter that is used in system algorithms. The time measured by each impulse radio radar unit is read, stored and utilized by the main control unit 905 on a periodic basis.

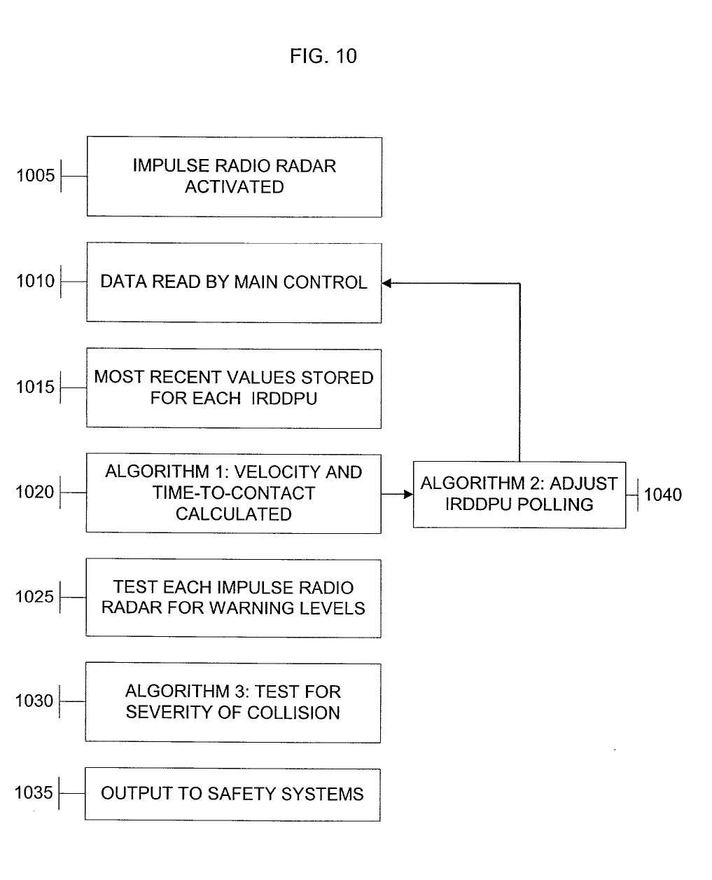

A flowchart depicting the operation of the system is set forth in FIG. 10. At step 1005, control unit 905 triggers the impulse radio radar 915 of each IRDDPU unit. If a plurality of IRDDPU units are used, the main control unit 905 controls the initiation of range determination of each distinct IPDDPU and controls and synchronizes their use. If a single or dome type omni directional impulse radio is used, no synchronization is required and main control unit 915 simply controls the dome impulse radio individually. At step 1005, the impulse radio radar is activated. This can occur in any number of ways known to those of ordinary skill in the art. For example, the system can be activated when the ignition is turned on. Or if protection is desired even when the engine is not running, an activation can occur when the automobile door is opened or a pressure switch can activate when an individual sits in the car seat. Again, any number of activation methodologies can be employed. At step 1010, control unit 905 poll of each IRDDPU unit to read its data. This data is then stored at step 1015 in memory at the control unit.

Next at step 1020, the control unit determines the time to impact. Time-to-impact is given by

Time=(Distance)/(Velocity)

where Distance is calculated in the IRDDPU using impulse radio radar distance measuring techniques described above and in the patents and patent applications incorporated herein by reference and Velocity is determined by dividing the difference between the two most recent measurements of Distance as determined by the impulse radio radar method.

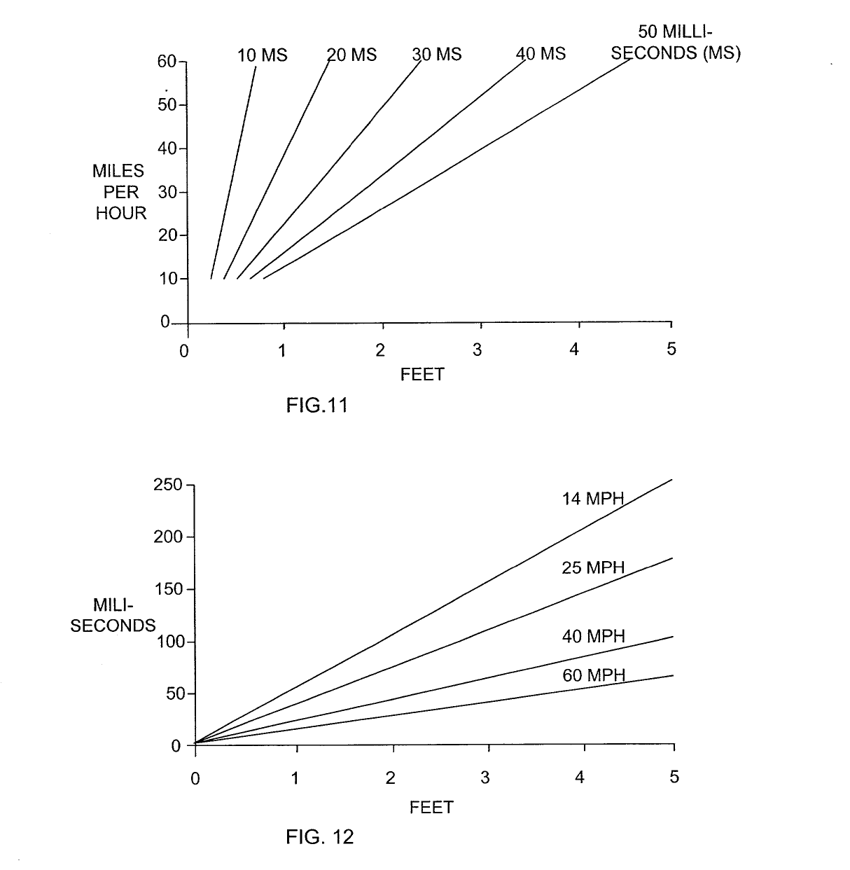

FIG. 11 illustrates the concept of time-to-impact as a function of distance, for various closing velocities. In order to provide a 20 millisecond warning before impact, FIG. 11 indicates that at 60 mph, a decision must be made and the warning issued when 1.75 feet remain between the colliding objects, and at 14 mph a decision must be made and the warning issued by 0.41 feet. When viewed as a function of range, as shown in FIG. 12, at a distance of 4 feet from impact, 45 milliseconds are available to reach a decision and issue a warning at velocities of 60 mph and 195 milliseconds are available at closing velocities of 14 mph. Illustratively, a decision that impact is about to occur can be made in about 10 to 20 milliseconds using a conventional microprocessor which would be located in main control unit 905.

Advantageously, velocity is also calculated at step 1020 and this resulting value is used at step 1040 to adjust the time interval at which the IRDDPUs are polled for information. In particular, the interval is adjusted so that the rangefinders are polled more frequently at higher velocities.

In addition, as indicated at step 1025, the system advantageously has multiple warning or response levels. These levels are a function of time-to-impact. Accordingly, upon computing time-to-impact at step 1020, the system then tests at step 1025 if that time requires a specific warning or response and issues the warning or response if it does. Such warning might include various levels or types of audible alarms or flashing lights on the instrument panel. Different responses might include these warnings or activation of the braking system.

Next, at step 1030 the system evaluates input from all the IRDDPUs to determine if a significant condition exists based on the time-to-impact, extent of the response of all units, and the sequence in which the individual units developed warning signals. If it determines that a serious collision is imminent, the system produces an output at step 1035 that can be used to initiate deployment of the airbag system. Advantageously, the output is provided about 10 to 40 milliseconds before collision occurs.

As illustrated in FIG. 13, a system of three impulse radio radars under the control of a single main control unit 905 is mounted on the front of the host vehicle. Depending on the shape of and size of the vehicle will determine the spacing and place of the impulse radio radars. For aesthetic purposes and because of the penetrability aspects of the impulse radios, the radars can be placed out of sight. For example, they could be place behind the front bumper or behind side molding. Again, this stands in sharp contrast to existing optical systems. Objects are detected within the volume out to about 4 feet from the radar units or at a distance as determined by manufacturers. Target distance data from within this volume is collected and analyzed by the system to determine if a collision will occur and to provide warning if required. A similar system might be mounted on the rear of the host vehicle.

A typical system algorithm for use with the forwardly armed impulse radio radars might provide levels of warning corresponding to a projected collision when any of the three impulse radio radar units indicate velocity of impact above 14 mph. In addition the location of the impacted area along the front of the vehicle can be factored into algorithms for interpreting accelerometer data, permitting an earlier decision from these units.

In FIG. 14, an individual impulse radio radar with a 60 degree beam width should be sufficient to cover the side panel of the front doors of the host vehicle. Although, an additional impulse radio radar could be placed for the rear occupants. Also, as a design choice several narrower degree beam width impulse radio radars can be used in conjunction to cover the area being protected. The beams project out from the side of the vehicle forming a sensing barrier. Objects are detected in the volume that extends out to 4 feet from the side of the vehicle. Again, target data from within this volume is collected and analyzed to determine if a collision will occur and to provide warning of a collision approximately 10 to 40 milliseconds before it occurs.

In the embodiment of FIG. 14 a typical system algorithm would provide levels of warning indicating velocity of impact at or above 14 mph. As will be apparent to those skilled in the art, the invention herein may be practiced in numerous variations of the specific embodiment disclosed. The operating parameters given are only illustrative and are intended to be conservative. Other parameters can be used.

In the preferred embodiment, the impulse radio radar system determines distance of the obstacle and time-to-impact and assesses the situation on those determinations. Further, it is described with reference to one or a plurality of impulse radio radars placed in the front and/or side of the vehicle. As mentioned above, numerous possibilities for placement of the impulse radio radars could be envisioned by those of ordinary skill in the art. For example, a single impulse radio radar with an omni directional antenna could be placed on the top of the car thereby creating in essence a radar bubble surrounding the entire car; or one antenna could be placed in the front of the car, one could be placed in the back and one for each side (as shown in FIGS. 13 and 14) and all of which have an associated IRDDPU and all of which could be controlled by main control unit 905. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. An impulse radio radar obstacle distance determination system, comprising:
at least one impulse radio radar associated with a vehicle, said impulse radio radar determines information concerning the surroundings of said vehicle;
an impulse radio distance determination processing unit (IRDDPU), said IRDDPU uses said information from said at least one impulse radio radar to ascertain the distance of said obstacle from said vehicle.

2. The impulse radio radar obstacle distance determination system of claim 1, further comprising an interface with an emergency apparatus to communicate said distance information.

3. The impulse radio radar obstacle distance determination system of claim 1, wherein said emergency apparatus is an airbag deployment system.

4. The impulse radio radar obstacle distance determination system of claim 1, wherein said emergency apparatus is an audible alerting system.

5. The impulse radio radar obstacle distance determination system of claim 1, wherein said emergency apparatus is a braking system.

6. The impulse radio radar obstacle distance determination system of claim 3, wherein said airbag deployment system is deployed when said obstacle is within a predetermined distance from said vehicle.

7. The impulse radio radar obstacle distance determination system of claim 3, wherein a safety belt pretensioning system is deployed when said obstacle is within a predetermined distance from said vehicle.

8. The impulse radio radar obstacle distance determination system of claim 4, wherein said audible alerting system is activated when said obstacle is within a predetermined distance from said vehicle.

9. The impulse radio radar obstacle distance determination system of claim 5, wherein said braking system is activated when said obstacle is within a predetermined distance from said vehicle.

10. An impulse radio radar pre-crash emergency apparatus activation system, comprising:
at least one impulse radio radar associated with a vehicle for detecting the distance from and the closure between said vehicle and an obstacle;
an emergency apparatus in communication with said impulse radio radar, said emergency apparatus being activated immediately preceding an imminent collision.

11. The impulse radio radar pre-crash emergency apparatus activation system of claim 10, further comprising an interface for communicating the distance and closure between said vehicle and said obstacle.

12. The impulse radio radar pre-crash emergency apparatus activation system of claim 10, wherein said emergency apparatus is an airbag safety system.

13. The impulse radio radar pre-crash emergency apparatus activation system of claim 10, wherein said emergency apparatus is an automatic braking system.

14. A method of determining the imminence of a crash between at least two objects comprising the steps of:
associating an impulse radio radar with one of said at least two objects;
determining the distance between and closure of said at least two objects using impulse radio means; and
ascertaining the inevitability of a collision between said at least two objects.

15. The method of determining the imminence of a crash between at least two objects of claim 14, wherein said step of determining the distance between and closure of said at least two objects is accomplished by determining the closing velocity between said at least two objects by impulse radio means and determining distance between said at two objects by impulse radio means and determining the time to collision between said at least two objects.

16. A method of deploying at least one emergency system immediately prior to a collision between two objects comprising the steps of:
associating at least on impulse radio radar with at least one object, said impulse radio radar is in communication with said at least one emergency system;
determining the distance between and closure of said at least two objects using impulse radio means and communicating to said at least one emergency system the imminence of a collision; and
activating said at least one emergency system immediately prior to said collision.

17. A method of deploying at least one emergency system immediately prior to a collision between two objects of claim 16, wherein said emergency apparatus is an airbag deployment system.

18. A method of deploying at least one emergency system immediately prior to a collision between two objects of claim 16, wherein said emergency apparatus is an emergency braking system.

19. A method of deploying at least one emergency system immediately prior to a collision between two objects of claim 16, wherein said emergency apparatus is an audible alerting system.

20. A method of deploying at least one emergency system immediately prior to a collision between two objects of claim 16, further comprising the step of notifying via a wireless communication means the report of the imminence of any accident and the position of said imminent accident.
